(19) United States
(12) Patent Application Publication
(10) Pub. No.: US 2007/0259312 A1
(43) Pub. Date: Nov. 8, 2007

(54) TURBINE FOR DENTAL BURR HANDPIECE

(76) Inventor: Shih Chun Wang, Chiayi City (TW)

Correspondence Address: RABIN & Berdo, PC, 1101 14TH STREET, NW, SUITE 500, WASHINGTON, DC, 20005, US

(21) Appl. No.: 11/740,676

(22) Filed: Apr. 26, 2007

(30) Foreign Application Priority Data
May 5, 2006 (TW) 95207711

(51) Int. Cl. A61C 1/05

(52) U.S. Cl. 433/132

(57) ABSTRACT

A turbine for dental burr handpiece includes a turbine main body having an axial central bore with a pivot shaft fixedly connected thereto, and multiple circles of blade sets surrounding the main body. The blades on two adjacent blade sets are staggered in arrangement. For guiding air, each blade in each of the blade sets is provided at a radially inner end adjacent to a radially outer end of a preceding blade with an air guiding slot, and two axially outmost blade sets are provided between respective axial outer side and a corresponding outer end of the central bore with an annular recess. High-pressure air introduced into the dental burr handpiece sequentially strikes against the blades on the multiple circles of blade sets to thereby quickly, smoothly, and stably rotate the pivot shaft at high speed without causing high wind resistance and turbulence, or noise due to vibration.

### FIELD OF THE INVENTION

The present invention relates to a turbine for dental burr handpiece, and more particularly, to a turbine for high-speed dental burr handpiece characterized in multiple circles of blade sets to enable the turbine to stably rotate at high speed without causing high vibration and noise.

### BACKGROUND OF THE INVENTION

Generally, a dentist uses a high-speed burr handpiece to treat a patient's decayed tooth. To operate the high-speed burr handpiece, high-pressure air is input to drive a turbine mounted in the handpiece, so that a drill bit clamped to a pivot shaft of the turbine is rotated at high speed to cut or remove decayed part from the tooth.

FIG. 1 is a sectional view of a conventional dental burr handpiece, which includes a transmission section A, on which a receiving section D is provided in perpendicular to an air inlet B and an air outlet C. A cutting tool, such as a grinder or a drill bit (not shown), is inserted in an end of the receiving section D. A turbine E is assembled to another end of the receiving section D. When air is introduced from an air source into the transmission section A via the air inlet B, the air strikes against one of many blades E1 aligned with the air inlet B to thereby rotate the turbine E and accordingly, the receiving section D, bringing the cutting tool or drill bit inserted in the receiving section D to rotate at high speed. When the blade E1 of the turbine E is rotated to a position aligned with the air outlet C, the high-pressure air in the turbine E is discharged via the air outlet C.

When the high-pressure air enters the turbine E via the air inlet B, it is temporarily held up in and among the blades E1 before reaching at the air outlet C. Since the high-pressure air has high flow rate and very strong pressure, it tends to vibrate the blades E1 and produces high-frequency noise. Moreover, each time the air is introduced into the turbine E, only one of the blades E1 is driven by the high-pressure air to rotate, resulting in non-uniform pressure distribution on the blades E1 to cause vibration of components inside the transmission section A and reduced service life of the dental burr handpiece.

It can be seen from FIG. 1 that the conventional dental burr handpiece includes a turbine E that has only one circle of blade set provided around an outer surface thereof. The introduced high-pressure air can strike only one of the blades E1 in one unit of time and therefore has a relatively small power output. That is, the turbine E could not bring the drill bit to rotate at a higher speed. And, the non-uniformly loaded blades E1 not only cause vibrated components, high-frequency noise, and shortened service life of the dental burr handpiece, but also adversely affect the treatment and therapy quality of the dental clinics and increase the patient's fear and discomfort during treatment of tooth.

### SUMMARY OF THE INVENTION

A primary object of the present invention is to provide a turbine for dental burr handpiece that has multiple circles of staggered blades, so that air introduced into the turbine may push multiple blades at the same time to increase the rotation speed of a drill bit clamped to the turbine and reduce vibration and noise during operation of the dental burr handpiece.

Another object of the present invention is to provide a turbine for dental burr handpiece that has air guiding slots provided on each of the blades thereof and two annular recesses provided at two axial outer ends thereof to guide high-pressure air held up at the blades to an air outlet for discharging, so as to reduce turbulence in the burr handpiece.

To achieve the above and other objects, the turbine for dental burr handpiece according to the present invention includes a turbine main body having an axial central bore and multiple circles of blade sets provided therearound. Each of the blade sets includes a plurality of blades. The blades on two adjacent blade sets are staggered in arrangement. For guiding out air, each blade in each of the blade sets is provided at a radially inner end adjacent to a radially outer end of a preceding blade with an air guiding slot, and two axially outmost blade sets are provided between respective axial outer side and a corresponding outer end of the central bore with an annular recess.

Wherein, the central bore has a pivot shaft associated therewith.

In an embodiment of the present invention, the pivot shaft is extended from two outer ends of the central bore. That is, the pivot shaft is integrally formed with the central bore.

The pivot shaft has a cutting tool or drill bit fixedly clamped thereto.

In an operable embodiment, the radially outer ends of the blades are curved end surfaces, which have an area and shape best for receiving and bearing high-pressure air.

In other embodiments, the radially outer ends of the blades are flat end surfaces, irregular end surfaces, or bend end surfaces.

With the above arrangements, high-pressure air introduced into the dental burr handpiece uniformly strikes against the blades on the multiple circles of blade sets to efficiently increase the rotation speed of the drill bit on the turbine. The air guiding slots and the two annular recesses at two axial outer ends of the turbine guide the high-pressure air held up at the blades to the air outlet to reduce turbulence in the dental burr handpiece and thereby reduces high-frequency noise caused by vibration. The quiet dental burr handpiece allows a dentist to treat patients in a good working environment and minimizes the patients' fear and discomfort during dental treatment.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a conventional dental burr handpiece;

FIG. 2 is a perspective view of a turbine for dental burr handpiece according to a preferred embodiment of the present invention;

FIG. 3 is an exploded view of FIG. 2;

FIG. 4 is a top plan view of FIG. 2;

FIG. 5 is a sectional view of FIG. 2;

FIG. 6 shows how air flows in the turbine for dental burr handpiece of the present invention; and

FIG. 7 is a perspective view of a turbine for dental burr handpiece according to a second embodiment of the present invention.

### DETAILED DESCRIPTION OF THE PREFERRED EMBODIMENTS

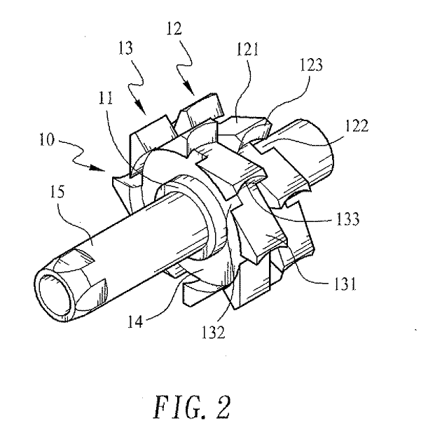

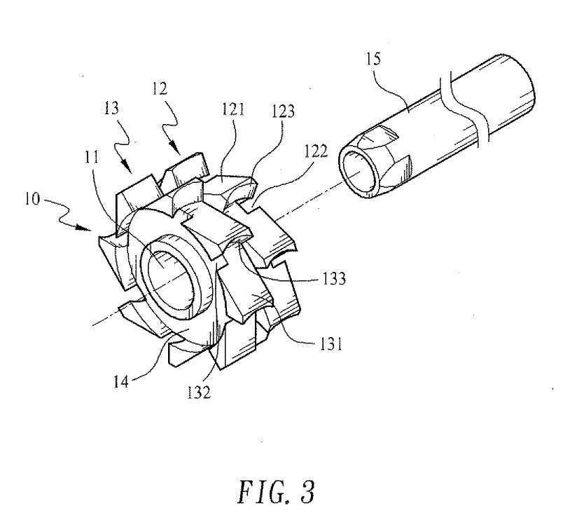

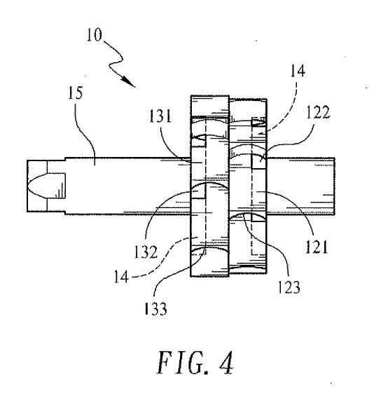

Please refer to FIGS. 2, 3, and 4. A turbine for dental burr handpiece according to a preferred embodiment of the present invention includes a turbine main body 10. As shown, the turbine main body 10 includes an axial central bore 11 and a plurality of circles of blade sets surrounding the main body 10. In the illustrated preferred embodiment, there are two circles of blade sets, namely, a first blade set 12 including a plurality of blades 121, and a second blade set 13 including a plurality of blades 131. It is noted the blades 121 of the first blade set 12 and the blades 131 of the second blade set 13 are staggered in arrangement; and both of the first and the second blade sets 12, 13 are so configured that an annular recess 14 is formed between their respective axially outer side and a corresponding outer end of the central bore 11 to serve as an air path.

An air guide slot 122 is formed on each blade 121 at a radial inner end thereof adjacent to a radial outer end of a preceding blade 121 and at one side adjacent to the corresponding annular recess 14; and the radial outer end of each blade 121 is formed into a transverse curved end surface 123, which has an area and shape best for receiving and bearing high-pressure air.

Similarly, an air guide slot 132 is formed on each blade 131 at a radial inner end thereof adjacent to a radial outer end of a preceding blade 131 and at one side adjacent to the corresponding annular recess 14; and the radial outer end of each blade 131 is formed into a transverse curved end surface 133, which has an area and shape best for receiving and bearing high-pressure air.

In an operable embodiment of the present invention, the turbine main body 10 includes a pivot shaft 15 axially mounted in and extended through the central bore 11.

In a most preferred embodiment, the pivot shaft 15 is formed by extending from two ends of the central bore 11 of the turbine main body 10. That is, the pivot shaft 15 is integrally formed with the central bore 11 for fixedly clamping a cutting tool or a drill bit (not shown) thereto.

In other operable embodiments of the present invention, the radially outer ends of the blades 121, 131 may be formed into flat end surfaces, irregular end surfaces, or bent end surfaces.

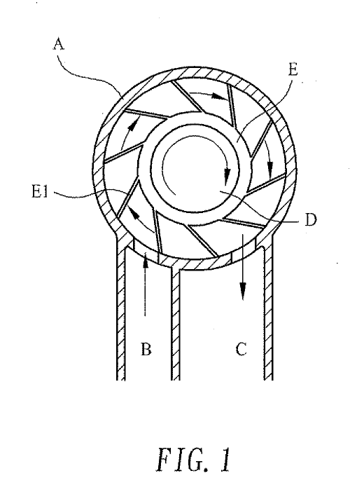

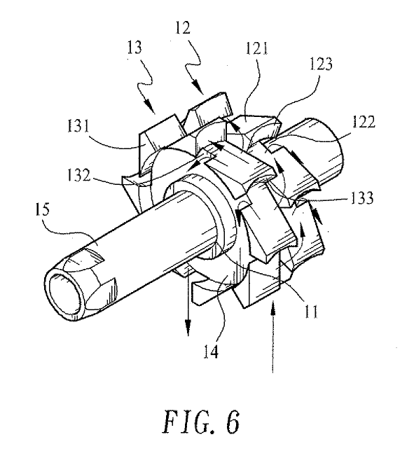

Please refer to FIGS. 1, 5, and 6. To use the turbine main body 10 of the present invention, first associate the pivot shaft 15 with the central bore 11 to complete the turbine main body 10, and then assemble the completed turbine main body 10 to a dental burr handpiece. Thereafter, high-pressure air is introduced into the handpiece via an air inlet 21 to drive the turbine main body 10 and accordingly, the pivot shaft 15 to rotate. The high-pressure air is then guided by the air guiding slots 122, 132 on the first and the second blade sets 12, 13 and the two annular recesses 14 to flow to an air outlet 22 and be discharged.

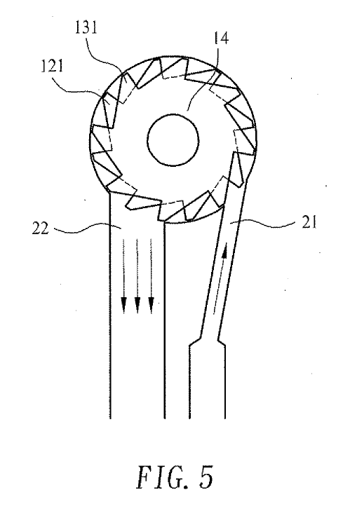

The high-pressure air introduced into the dental burr handpiece via the air inlet 21 first strikes against the blades 121 in the first blade set 12 to produce power for rotating the turbine main body 10. After striking against the blades 121 of the first blade set 12, a surplus part of the high-pressure air that is held up at the first blade set 12 passes through the air guiding slots 122 on the first blade set 12 to flow into the corresponding annular recess 14 and then be discharged via the air outlet 22 as indicated by the downward arrows in FIG. 5.

Since the blades 121 of the first blade set 12 and the blades 131 of the second blade set 13 are in staggered arrangement, and a space of a predetermined size is left between any two adjacent blades 121, 131, the above-mentioned surplus high-pressure air held up at the blades 121 will flow through the spaces between the blades 121 toward the second blade set 13 to strike against the curved end surfaces 133 of the blades 131 of the second blade set 13, causing the turbine main body 10 to rotate at an increased speed. With the specially designed turbine main body 10, the blades 131 are uniformly pushed by the high-pressure air to reduce vibration that is caused by the high-pressure air held up at the blades 131 and would indirectly affect the turbine main body 10 and other components in the dental burr handpiece. Moreover, high-frequency whooshing sound produced by the vibration may also be reduced.

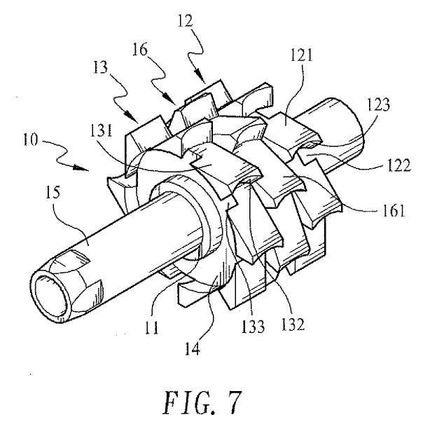

FIG. 7 shows a turbine for dental burr handpiece according to a second embodiment of the present invention. In the second embodiment, the turbine main body 10 is further provided between the first and the second blade set 12, 13 with a third blade set 16, which includes a plurality of blades 161.

In the turbine main body 10 with the first, second, and third blade sets 12, 13, 16 as configured in the second embodiment, the blades 121, 131, 161 pushed by the high-pressure air efficiently produce higher power from the high-pressure air to thereby increase the rotation speed of the turbine main body 10 while enables the turbine main body 10 to operate more stably.

In brief, with multiple circles of blade sets provided on the turbine main body 10, higher dynamic efficiency and power output may be achieved from the air supplied to the turbine main body 10 in the dental burr handpiece. The turbine main body 10 of the present invention may have increased torsion force to indirectly enable an increased rotation speed of the pivot shaft 15 and accordingly, the drill bit clamped thereto. The turbine main body 10 with multiple circles of blade sets enables the force of the high-pressure air held up in the turbine main body 10 to evenly distribute on the blades in different blade sets and thereby reduces the vibration and high-frequency noise caused by the quickly rotated drill bit. Therefore, the turbine for dental burr handpiece according to the present invention produces increased rotation speed while reduces noise during operation thereof.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A turbine for dental burr handpiece, comprising a turbine main body including an axial central bore and a plurality of circles of blade sets surrounding an outer circumferential surface of the central bore; each of the blade sets including a plurality of blades, and the blades on two adjacent blade sets being staggered in arrangement; and each blade in each of the blade sets being provided at a radially inner end adjacent to a radially outer end of a preceding blade with an air guiding slot, and two of the blade sets located around two axially outer ends of the central bore being provided between respective axial outer side and the corresponding outer end of the central bore with an annular recess, such that air introduced into the dental burr handpiece to rotate the turbine is finally guided by the air guiding slots and the two annular recesses to an air outlet and be discharged.

2. The turbine for dental burr handpiece as claimed in claim 1, further comprising a pivot shaft mounted in and extended through the central bore of the turbine main body.

3. The turbine for dental burr handpiece as claimed in claim 1, further comprising a pivot shaft integrally extended from two outer ends of the central bore of the turbine main body.

4. The turbine for dental burr handpiece as claimed in claim 1, wherein the blades of the blade sets have a transversely curved end surface.

5. The turbine for dental burr handpiece as claimed in claim 1, wherein the blades of the blade sets have a flat end surface.

6. The turbine for dental burr handpiece as claimed in claim 1, wherein the blades of the blade sets have an irregular end surface.

7. The turbine for dental burr handpiece as claimed in claim 1, wherein the blades of the blade sets have a bent end surface.

8. The turbine for dental burr handpiece as claimed in claim 2, wherein the pivot shaft has a cutting tool or drill bit fixedly clamped thereto.

9. The turbine for dental burr handpiece as claimed in claim 3, wherein the pivot shaft has a cutting tool or drill bit fixedly clamped thereto.
